(19) United States
(12) Patent Application Publication
(10) Pub. No.: US 2021/0376362 A1
(43) Pub. Date: Dec. 2, 2021

(54) Fuel Cell Including a Durability Enhancing Layer and Method of Manufacturing the Same

(71) Applicants: Hyundai Motor Company, Seoul (KR); Kia Motors Corporation, Seoul (KR)

(72) Inventors: Young June Park, Seoul (KR); Tae Hyun Yoo, Yongin-si (KR); Jun Woo Kim, Hwaseong-si (KR); Woo Jin Lee, Seoul (KR); Seong Un Im, Yongin-si (KR)

(21) Appl. No.: 17/004,163

(22) Filed: Aug. 27, 2020

(30) Foreign Application Priority Data
Jun. 1, 2020 (KR) 10-2020-0065968

(51) Int. Cl. H01M 8/0662; H01M 8/1004; H01M 4/88; H01M 8/0258

(52) U.S. Cl. CPC H01M 8/0662; H01M 8/0258; H01M 4/8807; H01M 8/1004

(57) ABSTRACT

A fuel cell includes an electrolyte membrane-electrode assembly, a durability enhancing layer formed on at least one side of the electrolyte membrane-electrode assembly, and a gas diffusion layer formed on a side of the durability enhancing layer opposite a side on which the electrolyte membrane-electrode assembly is formed, wherein the durability enhancing layer includes a hydrogen peroxide decomposition catalyst and a hydrogen ion conductive polymer and is formed on at least a part of the at least one side of the electrolyte membrane-electrode assembly.

### CROSS-REFERENCE TO RELATED APPLICATIONS

This application claims priority to Korean Patent Application No. 10-2020-0065968, filed in the Korean Intellectual Property Office on Jun. 1, 2020, which application is hereby incorporated herein by reference.

### TECHNICAL FIELD

The present disclosure relates to a fuel cell including a durability enhancing layer and a method of manufacturing the same.

### BACKGROUND

A fuel cell is driven on a principle of generating electrons using a redox reaction of oxygen and hydrogen, and is a key component of a hydrogen electric vehicle. In addition, the fuel cell typically includes a membrane electrode assembly (MEA), a gas diffusion layer (GDL), a separation plate, and the like. Specifically, the separation plate includes a reaction gas inlet and a reaction gas outlet and a flow path exists to allow hydrogen and oxygen to flow into the MEA. In addition, the MEA serves to produce electric power through an oxidation/reduction reaction. In addition, the gas diffusion layer serves to facilitate the reaction in which hydrogen and oxygen spread into the MEA and usually includes a base layer and a porous layer. Here, the base layer serves to give stiffness to the porous layer and the porous layer serves to allow hydrogen and oxygen to diffuse into the MEA, and thus the redox reaction proceeds smoothly.

Meanwhile, cerium is rapidly converted from Ce+3 to Ce+4 and has excellent anti-oxidation performance, low cost, and high specific surface area to be added to the electrolyte membrane or applied to the GDL as an anti-deterioration agent of the electrolyte membrane in the fuel cell.

Specifically, Korean Registered Patent No. 1810741 (Patent Document 1) discloses a fuel cell including a water repellent layer, which includes a polytetrafluoroethylene (PTFE) as a water repellent member and a cerium-containing oxide as a catalyst for decomposing hydrogen peroxide, on a catalyst layer of the GDL. However, when cerium is included in the GDL or electrolyte membrane as in Patent Document 1, cerium is capable of being evenly distributed in each layer to increase the overall cerium content but it is impossible to locally increase the cerium content in a severely deteriorated phenomenon of the electrolyte membrane. In addition, cerium oxide (CeO₂), which is a common use form of cerium, may have a strong cohesive force and may be heterogeneously disposed in the electrolyte membrane or GDL, and thus may have insufficient effect of preventing deterioration of the electrolyte membrane. In addition, when the cerium in the GDL is included in a bonding surface between the GDL and a base layer or an inner surface of the MEA rather than a bonding surface between the GDL and the MEA, there is a problem that the effect of preventing deterioration is very low.

Therefore, there is a need for research and development on a fuel cell, in which it is possible to locally increase the content of the hydrogen peroxide decomposition catalyst in a place where the deterioration of the electrolyte membrane is severe to be excellent in chemical durability and the hydrogen peroxide decomposition catalyst is provided on the bonding surface between the GDL and MEA, on the GDL to be excellent in preventing deterioration of the electrolyte membrane, and a method of preparing the same. Korean Registered Patent No. 1810741 (Publication date: 2016, 22 Apr.) discloses subject matter related to subject matter disclosed herein.

### SUMMARY

Embodiments of the present disclosure solve problems occurring in the prior art while advantages achieved by the prior art are maintained intact.

The present disclosure relates to a fuel cell including a durability enhancing layer, and a method of manufacturing the same. Particular embodiments relate to a fuel cell which includes a durability enhancing layer to be excellent in chemical durability and excellent in an adhesion between an electrolyte membrane-electrode assembly and a gas diffusion layer, and a method of manufacturing the same.

An aspect of the present disclosure provides a fuel cell including a durability enhancing layer on a GDL, the durability enhancing layer containing a hydrogen peroxide decomposition catalyst on a bonding surface between the GDL and an MEA, to be excellent in preventing deterioration of the electrolyte membrane and a method of preparing a fuel cell allowing a content of the hydrogen peroxide decomposition catalyst to be increased in a place where a deterioration phenomenon of the electrolyte membrane is severe, thereby being effective for improving chemical durability.

Technical problems solved by embodiments of the present inventive concept are not limited to the aforementioned problems, and any other technical problems not mentioned herein will be clearly understood from the following description by those skilled in the art to which the present disclosure pertains.

According to an aspect of the present disclosure, a fuel cell includes an electrolyte membrane-electrode assembly, a durability enhancing layer formed on at least one side of the electrolyte membrane-electrode assembly, and a gas diffusion layer formed on one side of the durability enhancing layer opposite the side on which the electrolyte membrane-electrode assembly is formed.

The durability enhancing layer includes a hydrogen peroxide decomposition catalyst and a hydrogen ion conductive polymer and is formed on at least a part of at least one side of the electrolyte membrane-electrode assembly.

According to an aspect of the present disclosure, a method of manufacturing a fuel cell includes stacking a durability enhancing layer on one side of a gas diffusion layer and stacking an electrolyte membrane-electrode assembly on one side of the durability enhancing layer opposite the side on which the gas diffusion layer is formed, the durability enhancing layer including a hydrogen peroxide decomposition catalyst and a hydrogen ion conductive polymer, and the durability enhancing layer being stacked on at least a part of at least one side of the electrolyte membrane-electrode assembly.

### BRIEF DESCRIPTION OF THE DRAWINGS

The above and other objects, features and advantages of embodiments of the present disclosure will be more apparent from the following detailed description taken in conjunction with the accompanying drawings, in which:

FIGS. 1 to 5 are cross-sectional views of a fuel cell according to an embodiment of the present disclosure;

FIG. 6 is an exploded view of a fuel cell in an embodiment of the present disclosure;

FIG. 7 is a schematic diagram of an embodiment of depositing a durability enhancing layer in a method of manufacturing a fuel cell according to an embodiment of the present disclosure; and

FIG. 8 is a schematic diagram of a spray used when depositing a durability enhancing layer in a method of manufacturing a fuel cell according to an embodiment.

### DETAILED DESCRIPTION OF ILLUSTRATIVE EMBODIMENTS

Throughout this specification, when a part may “include” a certain constituent element, unless specified otherwise, it may not be construed to exclude another constituent element but may be construed to further include other constituent elements.

Throughout this specification, when an element is referred to as being “on” another element, it can be “directly on” the other element or intervening elements may also be present.

### Fuel Cell

A fuel cell according to embodiments of the present disclosure includes an electrolyte membrane-electrode assembly, a durability enhancing layer formed on at least one side of the electrolyte membrane-electrode assembly, and a gas diffusion layer formed on a side opposite the side on which the electrolyte membrane-electrode assembly formed. Here, the electrolyte membrane-electrode assembly may include an electrolyte membrane and two electrodes formed on both sides of the electrolyte membrane, and the two electrodes may be an anode and a cathode, respectively.

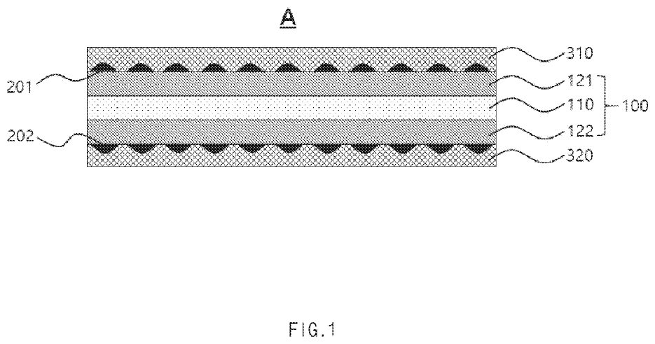

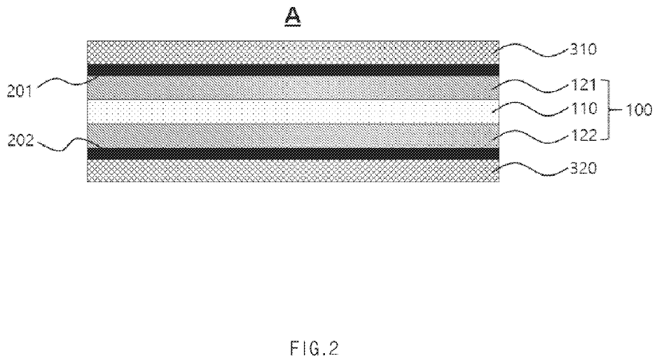

Referring to FIGS. 1 and 2, the fuel cell “A” according to embodiments of the present disclosure may include an electrolyte membrane-electrode assembly 100 including an electrolyte membrane no, a first electrode 121, and a second electrode 122, durability enhancing layers 201 and 202 formed on opposite sides of the electrolyte membrane-electrode assembly, and gas diffusion layers 310 and 320 respectively formed on an outer side of the durability enhancing layers 201 and 202, the outer side being opposite the sides on which the electrolyte membrane-electrode assembly is formed, respectively.

### Electrolyte Membrane-Electrode Assembly

The electrolyte membrane-electrode assembly (MEA) serves to produce power through an oxidation/reduction reaction, and is not particularly limited as long as it can be a shape or material included in a usual fuel cell.

Referring to FIGS. 1 and 2, the electrolyte membrane-electrode assembly 100 may include the electrolyte membrane no and two electrodes 121 and 122 formed on opposite sides of the electrolyte membrane. Here, the two electrodes may be an anode and a cathode, respectively.

The electrolyte membrane is an ion exchange membrane having electrical conductivity, and is not particularly limited as long as it can be used in a fuel cell. In addition, the electrolyte membrane may include a hydrogen peroxide decomposition catalyst. When the electrolyte membrane includes the hydrogen peroxide decomposition catalyst, a total amount of the hydrogen peroxide decomposition catalyst in the fuel cell increases, thereby effectively preventing deterioration of the electrolyte membrane.

### Durability Enhancing Layer

The durability enhancing layer 201, 202 is interposed on a bonding surface between the electrolyte membrane-electrode assembly (MEA) 100 and the gas diffusion layer (GDL) 310, 320 to increase adhesion of the two layers, and serves to improve chemical durability of the fuel cell through prevention of deterioration of the electrolyte membrane.

When using an adhesive for bonding the MEA to the GDL, the adhesive may be deformed into an ionic form in the fuel cell as an impurity to adversely affect the electrolyte membrane or electrodes, or to block a flow passage through which fluid passes, and thus performance and durability of fuel cell may be reduced. On the other hand, the durability enhancing layer of embodiments of the present disclosure includes a hydrogen peroxide decomposition catalyst to prevent deterioration of the durability of the fuel cell due to deterioration of the electrolyte membrane and includes a highly viscous hydrogen ion conductive polymer to improve the adhesion between the MEA and GDL while the durability enhancing layer allows hydrogen ions to smoothly move to improve the performance of the fuel cell.

In addition, the durability enhancing layer 201, 202 is formed on at least a portion of at least one side of the electrolyte membrane-electrode assembly 100.

For example, the durability enhancing layer 201, 202 may be a discontinuous layer, and may be in a form of a plurality of dots (see FIG. 1). That is, as shown in FIG. 1, in the fuel cell, a part of the electrolyte membrane-electrode assembly 100 on which the durability enhancing layer 201, 202 is not formed may be bonded to the gas diffusion layer 310, 320. When the form of the durability enhancing layer is in the form of the dots as described above, permeability of gas (oxygen and/or air) may become smooth, and thus the performance of the fuel cell may be improved. Here, when the durability enhancing layer is in the form of a plurality of dots, the durability enhancing layer may not be impregnated or depressed into the electrolyte membrane-electrode assembly or the gas diffusion layer but may exist as a discontinuous type layer.

As another example, the durability enhancing layer 201, 202 may be formed on one entire side of the electrolyte membrane-electrode assembly 100 (see FIG. 2).

Here, each dot constituting the durability enhancing layer 201, 202 may have an average diameter of 1 μm to 10 mm, or 10 μm to 5 mm. When the average diameter of each dot is greater than or equal to a diameter of a pore in the gas diffusion layer 310, 320, a contact area between the electrolyte membrane-electrode assembly 100 and the durability enhancing layer 201, 202 may be increased, thereby preventing the deterioration of the electrolyte membrane. When the average diameter of each dot is smaller than the diameter of the pore in the gas diffusion layer 310, 320, some pores in the gas diffusion layer 310, 320 may be filled with a durability enhancing layer, thereby increasing surface roughness of the gas diffusion layer 310, 320 and allowing the gas diffusion layer 310, 320 to be under uniform load upon bonding with the electrolyte membrane-electrode assembly 100.

In addition, the durability enhancing layer 201, 202 may have an average thickness of 50 nm to 50 μm, or 100 nm to 10 μm. When the average thickness of the durability enhancing layer is within the above range, the durability deterioration of the fuel cell due to deterioration of the electrolyte membrane may be prevented and the adhesion between the MEA and the GDL may be improved.

The durability enhancing layer 201, 202 includes a hydrogen peroxide decomposition catalyst and a hydrogen ion conductive polymer.

The hydrogen peroxide decomposition catalyst prevents membrane damage due to hydroxyl radicals (.OH) and has hydrophilicity to act as a water trap that prevents drying of the membrane even in a non-humidifying system.

In addition, the hydrogen peroxide decomposition catalyst may include, for example, at least one selected from the group consisting of transition metals and rare earth metals. Specifically, the hydrogen peroxide decomposition catalyst may include metals such as Ce, Mn, Fe, Pt, Pd, Ni, Cr, Cu, Ce, Rb, Co, Ir, Ag, Au, Rh, Ti, Zr, Al, Hf, Ta, Nb, and Os, oxides of the metals, or composites containing the metals. In particular embodiments, the hydrogen peroxide decomposition catalyst may include cerium (Ce).

The hydrogen peroxide decomposition catalyst may be included in the durability enhancing layer 201, 202 in a form of the metal, the metal oxide, the composite, and the like. Specifically, the hydrogen peroxide decomposition catalyst may be included in the durability enhancing layer 201, 202 in a form of cerium particles, cerium ions, cerium oxide, cerium composites, and the like. Here, the cerium composite may include, for example, a cerium-zirconium composite or a composite of cerium oxide and zirconium oxide. In particular embodiments, the durability enhancing layer 201, 202 may include cerium oxide (CeO₂). When the durability enhancing layer includes cerium oxide (CeO₂), cerium ions continuously act during an operation time of the fuel cell to effectively prevent membrane damage and to function as the water trap as described above.

The hydrogen ion conductive polymer increases a three-phase boundary area through contact with the electrode 121, 122 in the electrolyte membrane-electrode assembly 100 to increase an effective reaction area of the catalyst and plays a role to facilitate movement of the hydrogen ions. The hydrogen ion conductive polymer may be in a form of an ionomer, and in particular embodiments may be a perfluorosulfonate ionomer. Commercially available products of the hydrogen ion conductive polymer include, for example, Nation of DuPont, Flemion of Asahi Glass, Asiplex of Asahi Chemical, and Dow XUS of Dow Chemical, but the present disclosure is not limited thereto.

In addition, the hydrogen ion conductive polymer may be the same polymer as included in the electrode 121, 122 of the electrolyte membrane-electrode assembly 100.

The durability enhancing layer 201, 202 may include, for example, a hydrogen peroxide decomposition catalyst of 1.0 μg/cm² or more and a hydrogen ion conductive polymer of 1 μg/cm² or more. In particular embodiments, the durability enhancing layer may include a hydrogen peroxide decomposition catalyst of 1.1 to 5 μg/cm² or 1.3 to 3 μg/cm², and a hydrogen ion conductive polymer of 1 to 5 μg/cm² or 1.5 to 4 μg/cm² or more. Here, a reference area in a coating amount unit of the hydrogen peroxide decomposition catalyst and the hydrogen ion conductive polymer is based on 1 cm² of the gas diffusion layer 310, 320. That is, “1.0 μg/cm² or more of hydrogen peroxide decomposition catalyst” means that 1.0 μg or more of hydrogen peroxide decomposition catalyst is included based on 1 cm² of the gas diffusion layer 310, 320. Here, the hydrogen peroxide decomposition catalyst may be cerium.

When a content of the hydrogen peroxide decomposition catalyst in the durability enhancing layer 201, 202 is less than 1.0 μg/cm², influence on the durability improvement of the electrolyte membrane-electrode assembly 100 may be insufficient. In addition, when the content of the hydrogen peroxide decomposition catalyst in the durability enhancing layer 201, 202 is excessive, proton ion transfer is prevented to reduce performance of the electrolyte membrane-electrode assembly 100. Therefore, it is necessary to use an appropriate amount of the hydrogen peroxide decomposition catalyst to improve the durability of the electrolyte membrane-electrode assembly 100 without deteriorating the performance of the electrolyte membrane-electrode assembly 100.

In addition, when the content of the hydrogen ion conductive polymer in the durability enhancing layer 201, 202 is less than 1 μg/cm², lack of bonding strength between the gas diffusion layer 310, 320 and the electrolyte membrane-electrode assembly 100 may require a large bonding pressure and a high bonding temperature. Thus, the pores in the gas diffusion layer 310, 320 may disappear or the gas diffusion layer 310, 320 may be damaged, or shrinkage of the electrolyte membrane may occur to cause a boundary between the gas diffusion layer 310, 320 and the electrolyte membrane-electrode assembly 100 to collapse. In addition, when the content of the hydrogen ion conductive polymer in the durability enhancing layer 201, 202 is within the above range, flooding due to hygroscopicity of the hydrogen ion conductive polymer may be prevented and the bonding strength between the gas diffusion layer 310, 320 and the electrolyte membrane-electrode assembly 100 may be excellent, thereby improving the durability of the fuel cell.

The durability enhancing layer 201, 202 may include at least one additional material selected from the group consisting of TiO₂, zeolite, silica, silver, carbon nanotubes, graphene oxide, and platinum. When the durability enhancing layer 201, 202 includes TiO₂, zeolite, silica, or the like, it is possible to improve flux, fouling resistance, and salt rejection of the fuel cell. In addition, when the durability enhancing layer includes silver, carbon nanotubes, graphene oxide, or the like, electrical conductivity of the fuel cell and stiffness of an electricity-generating assembly (an assembly including the electrolyte membrane-electrode assembly 100, the durability enhancing layer 201, 202, and the gas diffusion layer 310, 320) may be improved.

### Gas Diffusion Layer

The gas diffusion layer 310, 320 may serve to enable hydrogen and oxygen to spread into the electrolyte membrane-electrode assembly 100 to facilitate the reaction and may include a base layer and a porous layer.

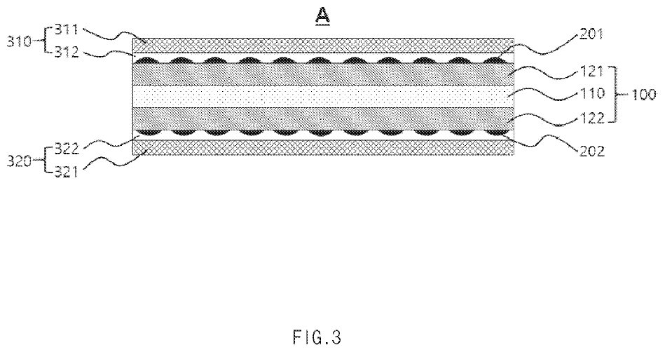

Referring to FIG. 3, the fuel cell “A” according to embodiments of the present disclosure may include the electrolyte membrane-electrode assembly 100 including the electrolyte membrane no, the first electrode 121, and the second electrode 122, the durability enhancing layers 201 and 202 formed on opposite sides of the electrolyte membrane-electrode assembly 100, and the gas diffusion layers 310 and 320 respectively formed on an outer side of the durability enhancing layers 201, 202, the outer side being opposite the side on which the electrolyte membrane-electrode assembly 100 is formed, and the gas diffusion layers 310 and 320 may include base layers 311 and 321 and porous layers 312 and 322. Here, the durability enhancing layers 201 and 202 may be formed on the porous layers 312 and 322 of the gas diffusion layers 310 and 320, respectively.

The base layers 311, 321 serve to give stiffness to the porous layers 312, 322, respectively.

Each base layer 311, 321 may be not particularly limited as long as it may be used as a base material of the gas diffusion layer 310, 320, and for example, may include carbon paper, carbon fiber, carbon felt, or carbon sheet. In addition, the base layer 311, 321 may be prepared according to a publicly known method, may use a commercially available carbon fiber matrix, or may be prepared by immersing and drying the carbon fiber matrix in an immersion liquid. Here, the immersion liquid may include a carbon precursor and a polymer. For example, the carbon precursor may include rayon, polyacrylonitrile (PAN), pitch, or the like. In addition, the polymer may include, for example, at least one selected from the group consisting of polytetrafluoroethylene (PTFE), tetrafluoroethylene-perfluoroalkyl vinyl ether copolymer (PFA), tetrafluoroethylene-hexafluoropropylene copolymer (FEP), polychlorotrifluoroethylene (PCTFE), tetrafluoroethylene-ethylene copolymer (ETFE), and polyfluorovinylidene (PVDF). In addition, the immersing may be repeated one to several times, and the drying may be performed at 20 to 40° C.

Each porous layer 312, 322 serves to allow hydrogen and oxygen to diffuse into the electrolyte membrane-electrode assembly 100, and thus the redox reaction proceeds smoothly.

In addition, the porous layer 312, 322 may be not particularly limited as long as it may be used as a porous layer of the gas diffusion layer 310, 320, and for example, may be prepared from a porous layer composition including a carbon-based powder and a binder. Here, a method of manufacturing the porous layer 312, 322 may be performed according to a known method of manufacturing a conventional porous layer.

The carbon-based powder may include at least one selected from the group consisting of, for example, carbon black, active carbon powder, activated carbon fiber, carbon aero-sol, carbon nanotube, carbon nanofiber, carbon nanohorn, and graphite powder. In addition, the binder may include at least one selected from the group consisting of, for example, polytetrafluoroethylene (PTFE), tetrafluoroethylene-perfluoroalkyl vinyl ether copolymer (PFA), tetrafluoroethylene-hexafluoropropylene copolymer (FEP), polychlorotrifluoroethylene (PCTFE), tetrafluoroethylene-ethylene copolymer (ETFE), and polyfluorovinylidene (PVDF).

In addition, the porous layer composition may include the hydrogen peroxide decomposition catalyst. That is, the porous layer 312, 322 may be prepared from the carbon-based powder, the binder, and the hydrogen peroxide decomposition catalyst. When the porous layer composition includes the hydrogen peroxide decomposition catalyst, the total amount of the hydrogen peroxide decomposition catalyst in the fuel cell may be increased to effectively prevent the deterioration of the electrolyte membrane.

Furthermore, the fuel cell according to embodiments of the present disclosure may further include a separation plate including a reaction gas inlet and a reaction gas outlet, on a side of the gas diffusion layer 310, 320, which is opposite the side that the durability enhancing layer 201, 202 is in contact with.

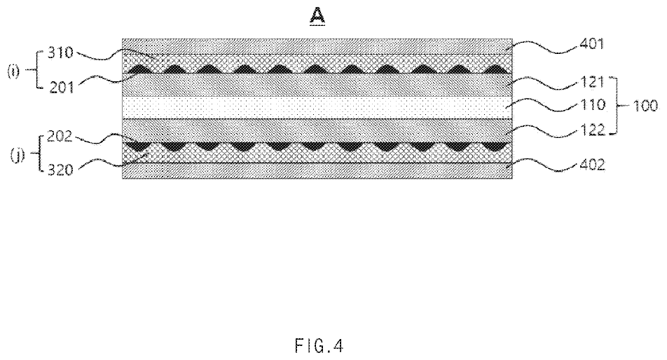

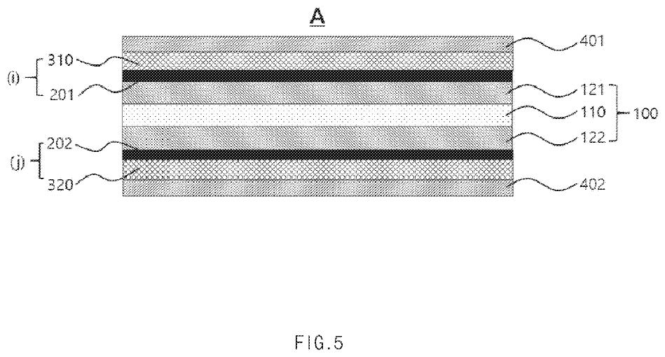

Referring to FIGS. 4 and 5, the fuel cell “A” according to embodiments of the present disclosure may include the electrolyte membrane-electrode assembly 100 including the electrolyte membrane 110, the first electrode 121, and the second electrode 122, the durability enhancing layers 201 and 202 formed on opposite sides of the electrolyte membrane-electrode assembly loo, and the gas diffusion layers 310 and 320 formed on outer sides of the durability enhancing layers 201, 202, respectively, and separation plates 401 and 402 formed on outer sides of the gas diffusion layers 310, 320, respectively.

Referring to FIGS. 4 to 6, the fuel cell “A” according to embodiments of the present disclosure may have a structure in which the first separation plate 401, a first multilayer film “i” including the first durability enhancing layer 201 and the first gas diffusion layer 310, the electrolyte membrane-electrode assembly 100 including the first electrode 121, the electrolyte membrane 110, and the second electrode 122, a second multilayer film “j” including the second durability enhancing layer 202 and the second gas diffusion layer 320, and the second separation plate 402 are sequentially stacked.

### Separation Plate

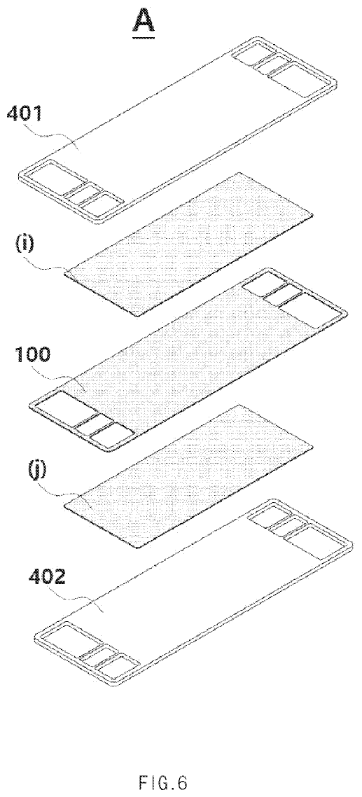

Referring to FIG. 6, each of the electrolyte membrane-electrode assembly 100 and the separation plates 401 and 402 may include the reaction gas inlet and the reaction gas outlet. Here, during the operation of the fuel cell, there is a limitation that deterioration is concentrated in the electrolyte membrane on the reaction gas inlet and the reaction gas outlet of the separation plate 401, 402 to weaken the durability of the electrolyte membrane. Here, the reaction gas may be air and/or hydrogen.

Thus, in the fuel cell according to embodiments of the present disclosure, a part of the durability enhancing layer 201, 202 corresponding to a position of at least one the reaction gas inlet and the reaction gas outlet of the separation plate 401, 402 may include an excess hydrogen peroxide decomposition catalyst, and for example, may include 2.5 μg/cm² or more, 2.5 to 15 μg/cm^{2,} or 3 to 5 μg/cm² of hydrogen peroxide decomposition catalyst.

The excess hydrogen peroxide decomposition catalyst as described above may increase an amount of hydrogen peroxide decomposition catalyst ions to the electrolyte membrane on the reaction gas inlet and/or the reaction gas outlet of the separation plate 401, 402, which is the position where the deterioration of the electrolyte membrane is concentrated, thereby effectively preventing the deterioration of the electrolyte membrane. The content of the hydrogen peroxide decomposition catalyst may be selected depending on the use of the electrolyte membrane-electrode assembly wo. When high durability of the electrolyte membrane-electrode assembly wo is required, an upper limit of the concentration of the hydrogen peroxide decomposition catalyst may be selected, but when an excess of the hydrogen peroxide decomposition catalyst is included, proton ion transfer may be lowered, resulting in a decrease in fuel cell performance.

Here, a reference area in a coating amount unit of the hydrogen peroxide decomposition catalyst is based on 1 cm² of the gas diffusion layer 310, 320. That is, “2.5 μg/cm² or more of hydrogen peroxide decomposition catalyst” means that 2.5 μg or more of hydrogen peroxide decomposition catalyst is included based on 1 cm² of the gas diffusion layer 310, 320. In particular embodiments, the hydrogen peroxide decomposition catalyst may be cerium.

In addition, when the electrolyte membrane-electrode assembly 100 of the fuel cell includes a sub-gasket, the sub-gasket may be partially formed on the electrode surface, and thus an area where the GDL is in contact with the MEA may not be flat. Therefore, when bonding the GDL to the MEA, although the same force is applied per unit area, a high load is locally applied to a part of the electrode surface on which the sub-gasket is formed, and a relatively low load is applied to other parts. Therefore, the parts under the relatively low load may lack the bonding force between the MEA and GDL. Accordingly, when the electrolyte membrane-electrode assembly 100 includes the sub-gasket, an excessive amount of the hydrogen ion conductive polymer may be applied to the parts other than the electrode surface on which the sub-gasket is formed to improve the bonding strength between the MEA and GDL.

In detail, when the electrolyte membrane-electrode assembly 100 includes the sub-gasket, the durability enhancing layer corresponding to a part other than the sub-gasket formed of the surface of the electrode may include the hydrogen peroxide decomposition catalyst of 2.5 μg/cm² or more.

In the fuel cell according to embodiments of the present disclosure as described above, the durability enhancing layer 201, 202 containing the hydrogen peroxide decomposition catalyst is provided on the bonding surface of the gas diffusion layer (GDL) 310, 320 and the electrolyte membrane-electrode assembly (MEA) 100 to be excellent in preventing the deterioration of the electrolyte membrane. In addition, the fuel cell includes the durability enhancing layer 201, 202 containing the highly viscous hydrogen ion conductive polymer provided on the bonding surface of the GDL and the MEA to be excellent in adhesion.

### Vehicle

A vehicle according to embodiments of the present disclosure includes the fuel cell “A” described with respect to FIGS. 1-6.

In particular embodiments, the vehicle may be a hydrogen electric vehicle.

### Method of Manufacturing a Fuel Cell

A method of manufacturing a fuel cell according to embodiments of the present disclosure includes stacking a durability enhancing layer on one side of a gas diffusion layer, and stacking an electrolyte membrane-electrode assembly on the other side opposite to the one side of the gas diffusion layer of the durability enhancing layer.

### Stacking Durability Enhancing Layer

In this operation, the durability enhancing layer 201, 202 is stacked on one side of the gas diffusion layer 310, 320.

The durability enhancing layer 201, 202 includes a hydrogen peroxide decomposition catalyst and a hydrogen ion conductive polymer. In particular embodiments, the hydrogen peroxide decomposition catalyst and the hydrogen ion conductive polymer are the same as described in the fuel cell “A”.

In addition, the durability enhancing layer 201, 202 may include a hydrogen peroxide decomposition catalyst of 1.0 μg/cm² or more and a hydrogen ion conductive polymer of 1 μg/cm² or more. Here, the specific coating amount in the hydrogen peroxide decomposition catalyst and the hydrogen ion conductive polymer in the durability enhancing layer 201, 202 is the same as described in the fuel cell “A”.

The durability enhancing layer 201, 202 is stacked on at least a portion of at least one side of the electrolyte membrane-electrode assembly loo. For example, a durability enhancing layer composition may be applied to one side of the gas diffusion layer 310, 320 to prepare the durability enhancing layer 201, 202. In particular embodiments, the durability enhancing layer composition may include a hydrogen peroxide decomposition catalyst, a hydrogen ion conductive polymer, and water.

The water has the effect of improving the workability of the durability enhancing layer composition and improving the dispersibility of the hydrogen ion conductive polymer. In addition, the water content in the durability enhancing layer composition may be adjusted to adjust hydrophilicity and hydrophobicity of the composition, and thus an amount of the composition introduced into pores of the hydrophobic gas diffusion layer may be adjusted. In addition, after application of the composition, the water in the durability enhancing layer composition may be dried to be removed. That is, the prepared durability enhancing layer may not contain the water.

The durability enhancing layer composition may include a first composition including the hydrogen peroxide decomposition catalyst and water, and a second composition including the hydrogen ion conductive polymer and the water. The durability enhancing layer composition may include the first composition containing the hydrogen peroxide decomposition catalyst and the second composition containing the hydrogen ion conductive polymer, as described above, to prevent oxidation of components, precipitation, chemical side reactions, or aggregation between components, to preserve characteristics of each of the hydrogen peroxide decomposition catalyst and the hydrogen ion conductive polymer, and to easily adjust the composition of the durability improving layer prepared by adjusting a mixing ratio of the first composition and the second composition.

Application of the durability enhancing layer composition may be performed by one method selected from the group consisting of a spray coating method, a 3D printing technique, an inkjet printing technique, a slot die coating method, a bar coating method, a powder dispersion coating method, a screen printing technique, and a knife coating method. In detail, the application of the durability enhancing layer composition may be performed by the spray coating method. When the application of the durability enhancing layer composition is performed by the spray coating method, an application area may be close to a reaction area to exhibit maximum efficiency. In addition, when the application of the durability enhancing layer composition is performed by the spray coating method, pressure during the application of the composition may be adjusted to adjust an average diameter of the applied composition, thereby adjusting roughness of the gas diffusion layer or adjusting a contact resistance and a contact area of the reaction area.

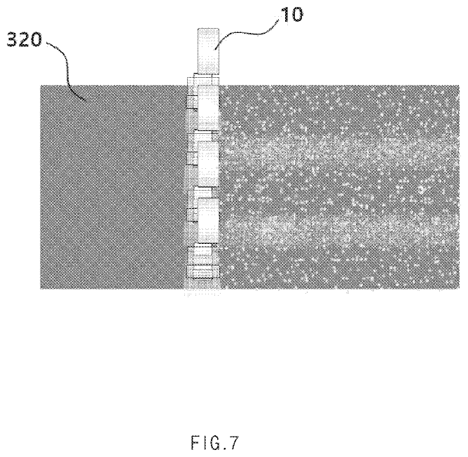

For example, the application of the durability enhancing layer composition may be performed using a plurality of sprays lo on the gas diffusion layer 320 as shown in FIG. 7. When using the plurality of sprays as described above, the mixing ratio of the first composition and the second composition in each spray may be adjusted to form the durability enhancing layer having a target composition in a target portion of the gas diffusion layer. For example, a problem occurs in that the durability of the electrolyte membrane on the reaction gas inlet and the reaction gas outlet of the separation plate is reduced by deterioration. In order to prevent the problems as described above, the durability enhancing layer composition having a high content of the hydrogen peroxide decomposition catalyst may be applied to the target portion where the deterioration of the electrolyte membrane is concentrated.

Furthermore, the durability enhancing layer 201, 202 may be a discontinuous layer, and may be formed in a plurality of dots or may be formed on one entire surface of the electrolyte membrane-electrode assembly loft The form of the durability enhancing layer 201, 202 is as described in the fuel cell “A”.

The durability enhancing layer composition may include at least one additional material selected from the group consisting of TiO₂, zeolite, silica, silver, carbon nanotubes, graphene oxide, and platinum.

### Stacking Electrolyte Membrane-Electrode Assembly

In this operation, the electrolyte membrane-electrode assembly 100 is stacked on the other side of the durability enhancing layer 201, 202 opposite the side on which the gas diffusion layer 310, 320 is formed.

The stacking of the electrolyte membrane-electrode assembly 100 may be performed by a method that may be commonly used in manufacturing a fuel cell.

In the method of manufacturing the fuel cell according to embodiments of the present disclosure as described above, it is possible to locally increase the content of the hydrogen peroxide decomposition catalyst at a position where the deterioration of the electrolyte membrane is severe, for example, at the reaction gas inlet and the reaction gas outlet, to be effective in improving the chemical durability of the fuel cell.

Hereinafter, aspects of the present disclosure will be described in more detail through Examples. However, these Examples are only for understanding the present disclosure, and the scope of the present disclosure is not limited to these Examples in any sense.

### EXAMPLE 1

### Stacking Durability Enhancing Layer

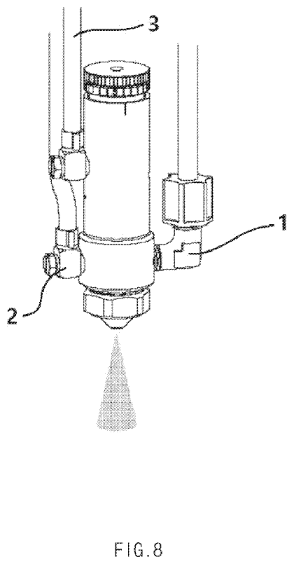

As shown in FIG. 8, a spray was used, a mixture of Nafion of DuPont and water in a 1:1 ratio as a first composition was injected into a first cylinder 1, and a mixture of cerium oxide and water in a 1:1 ratio as a second composition was injected into a second cylinder 2. As shown in FIG. 5, the first composition and the second composition were mixed and applied in a weight ratio of 7:3 to the gas diffusion layer 320 including the base layer and the porous layer. Thereafter, drying was performed at normal pressure and at a temperature of 150° C. to remove water in the durability enhancing layer composition to form a durability enhancing layer including 1.5 μg of cerium and 3 μg of Nafion per 1 cm² of the gas diffusion layer and having an average diameter of one dot of 67 μm.

### EXAMPLES 2 to 4 and COMPARATIVE EXAMPLES 1 and 2

Durability enhancing layers were formed in the same manner as in Example 1, except that the durability enhancing layers were prepared with compositions shown in Table 1 below.

TABLE 1

| Application amount of each component | | |
|---|---|---|
| per 1 cm² of gas diffusion layer | Cerium | Nafion |
| Example 1 | 1.5 μg | 3 μg |
| Example 2 | 0.5 μg | 3 μg |
| Example 3 | 1.5 μg | 0.8 μg |
| Example 4 | 1.5 μg | 5.5 μg |
| Comparative Example 1 | — | 3 μg |
| Comparative Example 2 | 1.5 μg | — |

### Test Example 1

### Durability Test

Fuel cell stacks using the gas diffusion layers in which the durability enhancing layers of the Examples and the Comparative Examples were formed, respectively, and then chemical durability and adhesion between the MEA and GDL were evaluated. Here, evaluation results are shown in Table 2.

In detail, the gas diffusion layers (GDLs) having the durability enhancing layers of the Examples and the Comparative Examples were bonded to surfaces of the catalyst layers for anode and cathode, which are opposite sides of the electrolyte membrane-electrode assembly (MEA), the separation plate was bonded to the other side of the gas diffusion layer, and a current collector plate was bonded on the other side of the separation plate, to prepare the fuel cells (see FIGS. 3 and 4).

### (1) Durability

As a reaction gas, a mixed gas containing hydrogen and air in a volume ratio of 1.5:2.0 was used, and the durability of the MEA was evaluated at 90° C. under a pressure condition of 20 kPa hydrogen and atmospheric pressure and a relative humidity of 30%.

For basic activation and soaking, the fuel cell stacks were treated for 24 hours under the above-described conditions, an initial voltage was measured, the cell voltage was maintained, and results of the cell voltage were calculated using regression fitting while current density of 1.2 A/cm² was maintained for 800 hours. In detail, a time taken until the 10% performance reduction occurred based on the initial voltage was measured.

### (2) Adhesion

A test piece, which was adhered with the durability enhancing layer between the MEA and GDL and had a size of 10 mm wide and 50 mm long, was used. Adhesion was evaluated using the UTM equipment, the GDL was fixed to one jig of the UTM equipment using a plate made of SUS material, and the MEA was fixed to the other jig. Then, peeling was performed at a speed of 50 mm/min and a gauge distance of 15 mm at 90° to measure load at which the adhesion between the MEA and GDL was torn.

TABLE 2

| | Durability (hr) | Adhesion (kgf) |
|---|---|---|
| Example 1 | 780 | 0.36 |
| Example 2 | 590 | 0.36 |
| Example 3 | 770 | 0.17 |
| Example 4 | 770 | 0.54 |
| Comparative Example 1 | 280 | 0.38 |
| Comparative Example 2 | 770 | 0.02 |

As shown in Table 2, Examples 1 to 4 were excellent in durability and adhesion.

On the other hand, Comparative Example 1 without cerium had very low durability, and Comparative Example 2 without hydrogen ion conductive polymer had very poor adhesion.

The fuel cell according to embodiments of the present disclosure includes the durability enhancing layer containing the hydrogen peroxide decomposition catalyst on the bonding surface between the GDL and MEA to be excellent in preventing deterioration of the electrolyte membrane. In addition, the fuel cell includes the durability enhancing layer containing the highly viscous hydrogen ion conductive polymer on the bonding surface between the GDL and MEA to be excellent in adhesion between the GDL and MEA.

In addition, in the method of manufacturing the fuel cell according to embodiments of the present disclosure it is possible to locally increase the content of the hydrogen peroxide decomposition catalyst in the place where the deterioration phenomenon of the electrolyte membrane is severe, for example, the reaction gas inlet and the reaction gas outlet, thereby being effective in improving chemical durability.

Hereinabove, although the present disclosure has been described with reference to exemplary examples, embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A fuel cell comprising:
an electrolyte membrane-electrode assembly;
a durability enhancing layer that includes a hydrogen peroxide decomposition catalyst and a hydrogen ion conductive polymer and is formed on at least a part of at least one side of the electrolyte membrane-electrode assembly; and
a gas diffusion layer formed on a side of the durability enhancing layer opposite a side on which the electrolyte membrane-electrode assembly is formed.

2. The fuel cell of claim 1, wherein the durability enhancing layer is a discontinuous layer comprising a plurality of dots formed on the at least one side of the electrolyte membrane-electrode assembly.

3. The fuel cell of claim 1, wherein the durability enhancing layer is formed on the entirety of one side of the electrolyte membrane-electrode assembly.

4. The fuel cell of claim 1, wherein the durability enhancing layer includes the hydrogen peroxide decomposition catalyst of 1.0 μg/cm² or more and the hydrogen ion conductive polymer of 1 μg/cm² or more.

5. The fuel cell of claim 1, wherein the hydrogen ion conductive polymer is in a form of an ionomer.

6. The fuel cell of claim 1, wherein the hydrogen peroxide decomposition catalyst includes at least one selected from a group consisting of transition metals and rare earth metals.

7. The fuel cell of claim 1, further comprising a separation plate including a reaction gas inlet and a reaction gas outlet on one side of the gas diffusion layer opposite a side in contact with the durability enhancing layer.

8. The fuel cell of claim ₇, wherein a portion of the durability enhancing layer corresponding to at least one of the reaction gas inlet and reaction gas outlet of the separation plate includes the hydrogen peroxide decomposition catalyst of 2.5 μg/cm² or more.

9. The fuel cell of claim 1, wherein the durability enhancing layer includes at least one additional material selected from a group consisting of TiO₂, zeolite, silica, silver, carbon nanotubes, graphene oxide, and platinum.

10. The fuel cell of claim 1, wherein:
the electrolyte membrane-electrode assembly includes a sub-gasket; and
a portion of the durability enhancing layer corresponding to a position other than the sub-gasket formed on a surface of the electrolyte membrane-electrode assembly includes the hydrogen peroxide decomposition catalyst of 2.5 μg/cm² or more.

11. The fuel cell of claim 1, wherein:
the gas diffusion layer includes a base layer and a porous layer;
the porous layer is prepared from a carbon-based powder, a binder, and a hydrogen peroxide decomposition catalyst; and
n electrolyte membrane of the electrolyte membrane-electrode assembly includes the hydrogen peroxide decomposition catalyst.

12. A method of manufacturing a fuel cell, the method comprising:
stacking a durability enhancing layer on one side of a gas diffusion layer; and
stacking an electrolyte membrane-electrode assembly on a first side of the durability enhancing layer opposite a second side on which the gas diffusion layer is stacked;
wherein the durability enhancing layer includes a hydrogen peroxide decomposition catalyst and a hydrogen ion conductive polymer; and
wherein the durability enhancing layer covers at least a part of at least one side of the electrolyte membrane-electrode assembly.

13. The method of claim 12, further comprising preparing the durability enhancing layer from a durability enhancing layer composition including a hydrogen peroxide decomposition catalyst, a hydrogen ion conductive polymer, and water.

14. The method of claim 13, wherein the durability enhancing layer composition includes a first composition including the hydrogen peroxide decomposition catalyst and the water and a second composition including the hydrogen ion conductive polymer and the water.

15. The method of claim 14, further comprising applying the durability enhancing layer composition as a mixing ratio of the first composition and the second composition, wherein the mixing ratio is adjusted to adjust a content of the hydrogen peroxide decomposition catalyst and the hydrogen ion conductive polymer in the durability enhancing layer.

16. The method of claim 15, wherein stacking the durability enhancing layer is performed using at least one from a group consisting of a spray coating method, a ₃D printing technique, an inkjet printing technique, a slot die coating method, a bar coating method, a powder dispersion coating method, a screen printing technique, and a knife coating method.

17. The method of claim 16, wherein:
applying the durability enhancing layer composition is performed by the spray coating method; and
the durability enhancing layer is a discontinuous layer including a plurality of dot shapes.

18. The method of claim 12, wherein the durability enhancing layer includes the hydrogen peroxide decomposition catalyst of 1.0 μg/cm² or more and the hydrogen ion conductive polymer of 1 μg/cm² or more.
